(19) United States
(12) Patent Application Publication
(10) Pub. No.: US 2012/0231189 A1
(43) Pub. Date: Sep. 13, 2012

(54) MULTILAYER LABEL AND PRODUCTS WITH LABEL

(76) Inventor: Yossef Zilber, Kfar Hess (IL)

(21) Appl. No.: 13/045,550

(22) Filed: Mar. 11, 2011

(51) Int. Cl. G09F 3/10; G09F 3/00

(52) U.S. Cl. 428/35.7; 428/41.8; 428/41.3

(57) ABSTRACT

A label including a plastic base layer (e.g. polypropylene), an overlaminate layer made of an engineering plastic, bonded to the base layer with a pressure-sensitive adhesive, the overlaminate layer having a thickness of between 30 and 40 microns, and a release liner placed over a self-adhesive surface of the base layer.

### FIELD OF THE INVENTION

The present invention relates generally to multilayer labels and products with such labels affixed thereto.

### BACKGROUND OF THE INVENTION

Labels are attached to containers, such as for advertisement and appearance. In many commercial applications, labels are applied to substrate containers or goods with high speed equipment. High speed equipment transfers the label, or facestock, from a liner release sheet to the substrate container. It is well known to use PP (polypropylene), and more specifically BOPP (bi-axially oriented PP), as a substrate for making labels. BOPP has been used to make ultra-thin labels with a PET (polyethylene terephthalate) release liner. For example, U.S. Pat. No. 7,399,509 to Virtanen, issued Jul. 15, 2008, describes advantages of a PET release liner as opposed to paper release liners for such ultra-thin labels, and also discusses advantages and disadvantages of PP and BOPP as a printing substrate as opposed to PE (polyethylene).

### SUMMARY OF THE INVENTION

The present invention seeks to provide a novel multilayer label with significantly greater toughness and durability than prior art labels, as is described more in detail hereinbelow.

In accordance with an embodiment of the invention, as opposed to the prior art, the label has enhanced thickness with a layered construction. In one embodiment, the label of the present invention does not use PET as a liner, rather a standard glassine paper liner. In one embodiment, an engineering plastic, such as but not limited to, PET, PC (polycarbonate), PMMA (polymethylmethacrylate), is used in the label as an overlaminate to protect the printed PP layer of the label; the PP and the engineering plastic together make up the facestock. The overlaminate enhances weatherability and endurance, and may be used to different finishes, such as but not limited to, a matte finish or glossy finish.

In one embodiment, the PET overlaminate has a thickness of 36 microns. This is three times thicker than conventional, prior art laminates used with 50 micron thick BOPP. The enhanced thickness provides previously unachieved toughness and durability.

In one embodiment, an extra-strength PSA (pressure sensitive adhesive) is used to bond the PET overlaminate to the printed layer. This provides flexibility, and ensures that even if the two layers start to separate, they will re-join due to the adhesive being constantly tacky.

### BRIEF DESCRIPTION OF THE DRAWINGS

The present invention will be understood and appreciated more fully from the following detailed description taken in conjunction with the drawings in which:

FIG. 1 is a simplified illustration of multilayer label, constructed and operative in accordance with an embodiment of the present invention;

FIG. 2 is a simplified illustration of a water bottle using the label of FIG. 1, in accordance with an embodiment of the present invention; and

FIG. 3 is a simplified illustration of a crate using the label of FIG. 1, in accordance with an embodiment of the present invention.

### DETAILED DESCRIPTION OF EMBODIMENTS

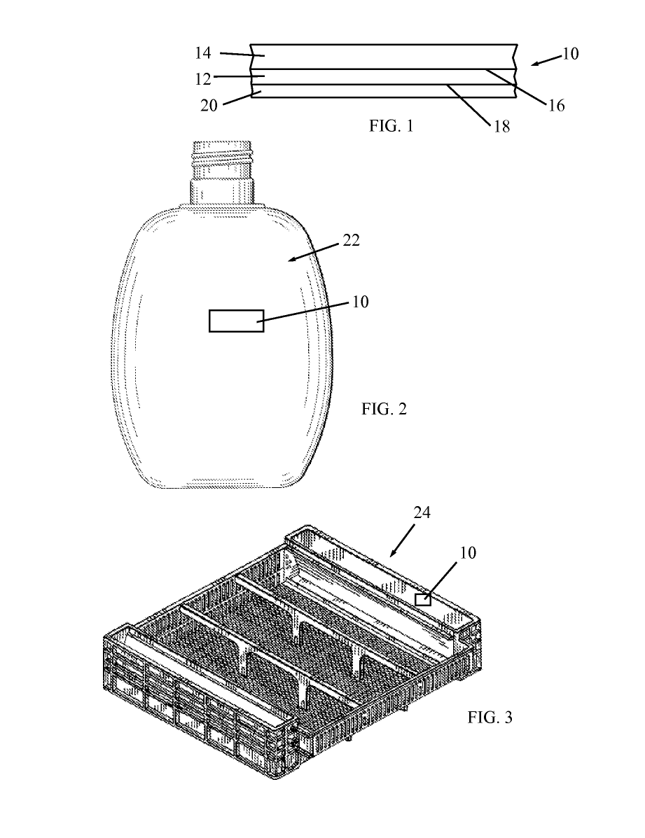

Reference is now made to FIG. 1, which illustrates a multilayer label 10, constructed and operative in accordance with an embodiment of the present invention. It is emphasized that the layers are not drawn to scale.

Label 10 is designed for difficult environments characterized by high temperatures, high humidity, scratching and abrasiveness. Label 10 adheres well to smooth, hard surfaces such as various metals (e.g., stainless steel, aluminum alloys and many others), and plastics (e.g., polycarbonate, ABS, and many others).

Label 10 includes a plastic base layer 12, which may be made of PP, such as but not limited to, BOPP, white, 0.059 mm (ISO 534). An overlaminate layer 14, made of an engineering plastic, such as but not limited to, PET (e.g., clear PET, 0.050 mm (ISO 534)), PC, or PMMA and others, is bonded to base layer 12 with an extra-strength pressure-sensitive adhesive (PSA) 16. Base layer 12 has a self-adhesive 18 covered initially by a release liner 20. A preferred material for release liner 20 is glassine paper, super-calendered, white. The total caliper is approximately 0.120 mm Paper release liners are sustainable materials and recyclable. However, other release liner materials may be used, such as film-based liners, e.g., an ultra-thin PET release liner. The self-adhesive 18 may be, for example, an acrylic based, clear and permanent adhesive, such as the adhesive available from ACTEGA RADCURE Inc., Wayne, N.J., US.

A suitable example of the material for overlaminate layer 14 is EXCELL, registered trademark for TORAY SAEHAN Inc.'s polyester film based on biaxially oriented polyethylene terephthalate. The EXCELL XP36 polyester film (142 gauge=36 microns, but the thickness may be in a range of 30-40 microns) has one side which is corona treated with good printability. The corona treated side offers excellent “wettability” for numerous kinds of inks and adhesives, for processes such as printing and laminating.

An example of PSA 16 is RAD-BOND 12PSFLV, which is an ultraviolet curable pressure sensitive adhesive which cures to a permanently tacky adhesive.

In an alternative embodiment, the plastic base layer 12 is not made of PP, but rather is made of the same engineering plastic as overlaminate layer 14 (e.g., PET, PC or PMMA). In such an embodiment, the label can be affixed to the article while the article is still hot or warm (that is, above room temperature) fresh after the manufacture thereof. Making the base layer 12 and the overlaminate layer 14 of the same engineering plastic prevents distortions, stresses and strains between the two layers due to a mismatch of thermal expansion coefficients and other properties.

Reference is now made to FIG. 2, which illustrates a water bottle 22 with label 10 affixed thereto, in accordance with a non-limiting embodiment of the present invention. Water bottle 22 is made of polycarbonate or polypropylene. The combination of the water bottle 22 and the label 10 provides significantly greater longevity of the labeled bottle, thereby allowing the bottle to be re-used more than prior art bottles.

Reference is now made to FIG. 3, which illustrates a vegetable and produce crate or box 24 with a label 10 affixed thereto. The combination of the crate 24 and the label 10 provides significantly greater longevity of the labeled crate, thereby allowing the crate to be re-used more than prior art crates.

It will be appreciated by persons skilled in the art that the present invention is not limited by what has been particularly shown and described hereinabove. Rather the scope of the present invention includes both combinations and subcombinations of the features described hereinabove as well as modifications and variations thereof which would occur to a person of skill in the art upon reading the foregoing description and which are not in the prior art.

What is claimed is:

1. A label comprising:
a plastic base layer;
an overlaminate layer made of an engineering plastic, bonded to said base layer with a pressure-sensitive adhesive, said overlaminate layer having a thickness of between 30 and 40 microns; and
a release liner placed over a self-adhesive surface of said base layer.

2. The label according to claim 1, wherein said base layer is made of polypropylene.

3. The label according to claim 1, wherein said release liner comprises a glassine paper, super-calendered, white liner.

4. The label according to claim 1, wherein said pressure-sensitive adhesive comprises an ultraviolet curable pressure sensitive adhesive which cures to a permanently tacky adhesive.

5. The label according to claim 1, wherein said self-adhesive comprises an acrylic based, clear and permanent adhesive.

6. The label according to claim 1, wherein said engineering plastic comprises polyethylene terephthalate.

7. The label according to claim 1, wherein said engineering plastic comprises polycarbonate.

8. The label according to claim 1, wherein said engineering plastic comprises polymethylmethacrylate.

9. The label according to claim 1, wherein said base layer and said overlaminate layer are made of the same material.

10. The label according to claim 1, wherein said base layer and said overlaminate layer have generally identical thermal expansion coefficients.

11. An article comprising:
a water bottle with a label affixed thereto, said label comprising a base layer made of polypropylene, an overlaminate layer made of an engineering plastic, bonded to said base layer with a pressure-sensitive adhesive, said overlaminate layer having a thickness of between 30 and 40 microns, and a release liner placed over a self-adhesive surface of said base layer.

12. An article comprising:
a crate with a label affixed thereto, said label comprising a base layer made of polypropylene, an overlaminate layer made of an engineering plastic, bonded to said base layer with a pressure-sensitive adhesive, said overlaminate layer having a thickness of between 30 and 40 microns, and a release liner placed over a self-adhesive surface of said base layer.
